(19) United States
(12) Patent Application Publication
(10) Pub. No.: US 2025/0333313 A1
(43) Pub. Date: Oct. 30, 2025

(54) IMPROVED CO2 TO CO CONVERSION METHOD AND SYSTEM

(71) Applicant: D-CRBN BV, Antwerp (BE)

(72) Inventors: Georgi TRENCHEV, Antwerp (BE); Gill SCHELTJENS, Wilrijk (BE); David ZIEGLER, Antwerp (BE)

(21) Appl. No.: 18/864,965

(22) PCT Filed: May 16, 2023
(86) PCT No.: PCT/EP2023/063144

§ 371 Date: Nov. 12, 2024

(30) Foreign Application Priority Data
May 18, 2022 (BE) 2022/5380

(51) Int. Cl. C01B 32/40; B01J 8/00; B01J 8/18; B01J 8/42

(52) U.S. Cl. CPC C01B 32/40; B01J 8/0015; B01J 8/1827; B01J 8/42; B01J 2208/00752

(57) ABSTRACT

The current invention relates to a method for producing CO from CO2, comprising the steps of: providing process gas comprising CO2, and optionally CO, to a plasma jet generator; igniting a plasma in the process gas by the plasma jet generator, thereby obtaining a plasma jet comprising CO and O species; introducing the plasma jet into a carbon reaction chamber; extracting product gas from the reaction chamber, said product gas comprising said CO and CO2 and recycling at least part of the product gas and providing said product gas comprising CO and CO2 to a plasma jet generator. The invention also relates to a system for converting CO2 to CO, comprising: a carbon reaction chamber and a plasma jet generator, wherein said gas outlet of the reaction chamber is in fluid communication with the process gas inlet of a plasma jet generator.

### FIELD OF THE INVENTION

The present invention relates to a method and system for production of carbon monoxide (CO) from carbon dioxide (CO2). The present invention also relates to the field of plasma-assisted and/or plasma-induced chemical reactions.

### BACKGROUND

The transition to a climate-neutral society is both an urgent challenge and an opportunity to build a better future for all. All parts of society and economic sectors will play a role, from the power sector to industry, mobility, buildings, agriculture and forestry. Carbon Capture and Storage (CCS) has been regarded as a viable option for CO2 mitigation for several years. Most competing technologies, and subsequently, emerging companies in CCS, aim to capture CO2 and store it in a specifically designed site (usually underground). While this method is effective for the time being, storing CO2 is not a sustainable solution, and can lead to a number of long term issues with storage maintenance and transportation.

CCS is now evolving into CCU (Carbon Capture and Utilization). The CCU approach differs, as it aims to use the CO2 gas as a raw material. Using innovative processes to split CO2 molecules into valuable products such as carbon monoxide (CO), molecular oxygen (O2) and C is the key towards re-assigning it as a reusable product. For instance, CO is a highly valuable commodity used for a variety of chemical processes, from metal production to fuels and plastics. CO is used directly in the production of novel polyurethane materials such as Cardyon®. Very much like plastics, metals and biomass, the future also holds conversion pathways of reusability for CO2.

Within the CCU market, different types of technologies have emerged. Membrane reactor systems for direct thermal splitting have been tested to varying amounts of success, with conversion ratios between 0.5% and 2%. Conversion using a co-reactant gas (methane CH4) is also a recurrent field of study. However this method suffers from problematic soot deposition. Electrochemical conversion of CO2 is in advanced development, but relies on the solubility of CO2 in liquids (which is limited), and leads to the formation of a number of residues, which are difficult to separate. In solar thermochemical conversion of CO2, concentrated solar energy is used to heat up the CO2 to splitting temperatures. A number of fundamental questions need to be challenged for this technology to become viable in industry.

The present invention relates to a plasma-based CO2-to-CO conversion technique. A plasma-based conversion technique is described in
“Plasma technology—a novel solution for CO2 conversion?”, Ramses Snoeckx ORCID logo* and Annemie Bogaerts ORCID logo*, Chem. Soc. Rev., 2017, 46, 5805-5863, DOI: 10.1039/C6CS00066E (Review Article)

Herein, it is stated that “The highest conversions of 42% were obtained for packed-bed DBDs while the highest energy efficiency of 23% was obtained with a pulsed power DBD.” DBD herein refers to Dielectric barrier discharges (DBDs), also called “silent discharges”. A DBD consists of two plane-parallel or concentric metal electrodes and, as its name suggests, it contains at least one dielectric barrier (e.g. glass, quartz, ceramic material or polymers) in between the electrodes. The purpose of the dielectric barrier is to restrict the electric current and thus to prevent the formation of sparks and/or arcs. A gas flow is applied between the (discharge) gap, which can typically vary from 0.1 mm, to over 1 mm to several cm. In general, DBDs operate at approximately atmospheric pressure (0.1-10 atm, but usually around 1 atm), while an alternating voltage with an amplitude of 1-100 kV and a frequency of a few Hz to MHz is applied between both electrodes.

U.S. Pat. No. 4,190,636 describes method of producing carbon monoxide in a plasma arc reactor is disclosed, wherein carbon dioxide is delivered to an arc to form a plasma into which solid carbon is delivered. WO2015039195 discloses a method for carbon dioxide capturing and its transformation into gaseous fuel, wherein carbon dioxide alone or in admixture with water vapor and/or methane is subjected to pulsed and/or acoustic treatment and passes through a thermally activated zone with temperature 800° C. to 1000° C. WO2021142919 discloses a plasma-based carbon fixation system, comprising: a plasma reactor, a first separator, a condenser and a second separator.

Plasma-based conversion of CO2 to CO suffers from two main drawbacks: limited conversion rate and limited energy efficiency; both of which prevent it from entering the industrial stage. Furthermore, the lack of a method for heat and oxygen recuperation limits the technology.

The present invention aims to provide an alternative and/or improvement to the prior art plasma-based conversion techniques, which is scalable to industrial scale and/or improves the conversion efficiency.

### SUMMARY OF THE INVENTION

The present invention relates to a method and system to convert CO2 into its original building blocks to enable a carbon based circular economy. Hereto, plasma technology, preferably atmospheric plasma technology, is used to split CO2 into carbon monoxide (CO) and oxygen (O or O2), which CO can be used downstream for the production of syngas or other added value products like biofuel, formic acid, toluene diisocyanate and others.

The technique of the present invention is a scalable plasma-based CO2 conversion technology. In particular, the present invention aims to:
Increase the conversion rate of CO2 to CO;
Boost the CO production; and
Increase the energy-efficiency

Recycling unreacted reagents is a known technique in chemical processing. An issue related to recycling unreacted CO2 to the plasma reactor is the requirement to separate it from CO and oxygen species, which drastically increases the energy requirements and decreases its energy efficiency.

Recycling the product stream of the plasma generator in its entirety, leads to recombination of oxygen and CO species to CO2; which lowers the conversion per pass and energy efficiency. The recombination of oxygen and CO eventually reaches equilibrium with the dissociation of CO2 to oxygen and CO per pass; preventing high concentrations of CO to be obtained without separation.

The present invention and embodiments thereof serve to provide a solution to one or more of above-mentioned disadvantages. To this end, the present invention relates to a method according to claim 1. Preferred embodiments of the method are shown in any of the claims 2 to 9.

In particular, claim 1 allows the oxygen species to be fixated as CO; preventing recombination towards CO2. This advantageously allows the product stream of CO2 and CO to be recycled without significant reductions in conversion rate per pass; thereby obtaining much higher energy efficiency and allowing higher final concentrations of CO.

In a second aspect, the present invention relates to a system according to claim 10.

Preferred embodiments of the method are shown in any of the claims 11 to 15.

The combination of oxygen fixation through carbon donor particles, and recycling at least a part of the obtained CO/CO2 mixture without requiring purification or separation has a beneficial influence on the total CO2 conversion as well as energy efficiency. Recirculation of the product gas for two or more times through a plasma jet generator and carbon reaction chamber for oxygen fixation increases the total CO2 conversion significantly.

### DESCRIPTION OF FIGURES

The following numbering refers to: (1) plasma jet outlet; (2) plasma jet generator; (3) carbon reaction chamber; (4) plasma jet afterglow; (5) carbon-donor particles; (6) carbon reaction chamber; (7) a fixed carbon particle bed; (8) entrance of a mixture of CO2, CO and O2; (9) CO-enriched gas stream; (10) carbon reaction chamber; (11) pulverized carbon particles; (12) entrance of a mixture of CO2, CO and O2; (13) CO-enriched gas stream; (14) carbon-donor particle inlet; (15) process gas comprising CO2 and CO; (16) reactant gas comprising CO2; (17) recycled product gas comprising CO2 and CO; (18) plasma jet; (19) plasma jet generator; (20) plasma jet afterglow; (21) conversion of CO2 to CO and ½ O2; (22) carbon reaction chamber comprising carbon-donor particles; (23) conversion of CO, C and O to 2CO; (24) carbon-donor particle inlet; (25) product gas comprising CO2 and CO; (26) extracted product gas; (27) separation unit; (28) CO stream; (29) CO2 stream; (30) plasma generating means; (31) fluid communication between plasma jet generator and carbon reaction chamber.

The following description of the figures of specific embodiments of the invention is merely exemplary in nature and is not intended to limit the present teachings, their application or uses. Throughout the drawings, corresponding reference numerals indicate like or corresponding parts and features.

FIG. 1 illustrates the temperature dependence of the reversible Boudouard reaction.

FIG. 2 illustrates an embodiment of the system of the present invention wherein the carbon reaction chamber is a fluidized carbon bed.

FIG. 3 illustrates an embodiment of the system of the present invention wherein the carbon reaction chamber is a fixed carbon bed.

FIG. 4 illustrates a carbon reaction chamber using pulverized carbon-donor particles according to an embodiment of the present invention.

FIGS. 5A and 5B illustrate the CO₂ conversion and energy efficiency per pass for a system without carbon reaction chamber (C. ex. 5) and a system with carbon reaction chamber, according to the present invention (Ex. 6).

FIGS. 6A and 6B illustrate a process flow and associated mass balances according to an embodiment of the present invention.

FIG. 7 presents a schematic view of an embodiment of the present invention.

FIG. 8 presents a schematic continuous feeding mechanism for a fluidized carbon bed according to an embodiment of the present invention.

FIG. 9 presents a system according to an embodiment of the present invention, wherein a multitude of plasma reactors shares a continuous fluidized carbon bed.

### DETAILED DESCRIPTION OF THE INVENTION

The present invention concerns a method and a system for producing CO from CO2.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

The expressions “carbon reaction chamber” and “reaction chamber” refer to the same carbon reaction chamber comprising carbon donor particles as described in this disclosure.

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

The expression “% by weight”, “weight percent”, “% wt” or “wt %”, here and throughout the description unless otherwise defined, refers to the relative weight of the respective component based on the overall weight of the formulation.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In a first aspect, the invention relates to a method for producing CO from CO2; the method comprises the steps of:
i. providing process gas comprising CO2 and optionally CO and oxygen, to a plasma jet generator;
ii. igniting a plasma in the process gas by the plasma jet generator, thereby obtaining a plasma jet comprising CO and oxygen species;
iii. introducing the plasma jet into a carbon reaction chamber comprising carbon donor particles, thereby allowing oxygen species in the plasma jet to preferentially bind with carbon to form CO;
iv. extracting product gas from the reaction chamber, said product gas comprising said CO and CO2; and
v. recycling at least part of the product gas and providing said product gas comprising CO and CO2 to a plasma jet generator.

The combination of a carbon donor particles (step iii.) and a recycle of the product gas without separation of CO2 and CO is synergistic. By introducing carbon donor particles, O species are fixated to CO rather than the formation of O2. This fixation of O species significantly increases the conversion of CO2 when recycling the product gas in its entirety; as it prevents recombination (i.e. the backwards reaction of oxygen and CO forming CO2). This effectively allows recirculation or recycling of the CO and CO2 mixture, rather than separating CO2 from said product gas and only recycling the separated CO2. Recycling without fixation of O species (according to step iii.) leads to drastically reduced conversion per pass, as well as energy efficiency, as the amount of recombination between CO and O species increases with their concentration in the process gas mixture. A further advantage is that a much higher CO concentration and CO/CO2 ratio can be obtained. This drastically reduces or even fully eliminates the requirements when separating CO2 and CO.

It has been shown that recycling at least part of the product gas and providing said product gas comprising CO and CO2 to a plasma jet generator has a beneficial influence on the CO2 conversion. Recirculation of the product gas for two or more times through a plasma jet generator in combination with a carbon reaction chamber for oxygen removal increases the total CO2 conversion significantly.

The recycling referred to in this disclosure can refer to the recycling of at least part of the product gas and providing said product gas comprising CO and CO₂ to the same plasma jet generator (as a recirculation) or providing said product gas comprising CO and CO2 to a different or second plasma jet generator (as a multistage recycling).

The invention relates to a method for producing CO from CO₂; the method comprises the steps of:
i. providing process gas comprising CO₂ and optionally CO and oxygen, to a plasma jet generator;
ii. igniting a plasma in the process gas by the plasma jet generator, thereby obtaining a plasma jet comprising CO and oxygen species;
iii. introducing the plasma jet into a carbon reaction chamber comprising carbon donor particles, thereby allowing oxygen species in the plasma jet to preferentially bind with carbon to form CO;
iv. extracting product gas from the carbon reaction chamber, said product gas comprising said CO and CO₂; and
v. recycling at least part of the product gas and providing said product gas comprising CO and CO₂ to said plasma jet generator or to a second plasma jet generator.

In some embodiments, the invention thus relates to a method for producing CO from CO2; the method comprises the steps of:
i. providing process gas comprising CO2 and optionally CO and oxygen, to a plasma jet generator;
ii. igniting a plasma in the process gas by the plasma jet generator, thereby obtaining a plasma jet comprising CO and oxygen species;
iii. introducing the plasma jet into a carbon reaction chamber comprising carbon donor particles, thereby allowing oxygen species in the plasma jet to preferentially bind with carbon to form CO;
iv. extracting product gas from the carbon reaction chamber, said product gas comprising said CO and CO2; and
v. recycling at least part of the product gas and providing said product gas comprising CO and CO2 to said plasma jet generator.

In other embodiments, the invention thus relates to a method for producing CO from CO2; the method comprises the steps of:
i. providing process gas comprising CO2 and optionally CO and oxygen, to a first plasma jet generator;
ii. igniting a plasma in the process gas by the plasma jet generator, thereby obtaining a plasma jet comprising CO and oxygen species;
iii. introducing the plasma jet into a carbon reaction chamber comprising carbon donor particles, thereby allowing oxygen species in the plasma jet to preferentially bind with carbon to form CO;
iv. extracting product gas from the carbon reaction chamber, said product gas comprising said CO and CO2; and
v. recycling at least part of the product gas and providing said product gas comprising CO and CO2 to a second plasma jet generator.

A plasma is subsequently ignited in the product gas by the second plasma jet generator, thereby obtaining a plasma jet comprising CO and oxygen species; and the plasma jet is introduced into a second carbon reaction chamber comprising carbon donor particles, thereby allowing oxygen species in the plasma jet to preferentially bind with carbon to form CO, and the product gas is extracted from the carbon reaction chamber, said product gas comprising said CO and CO2.

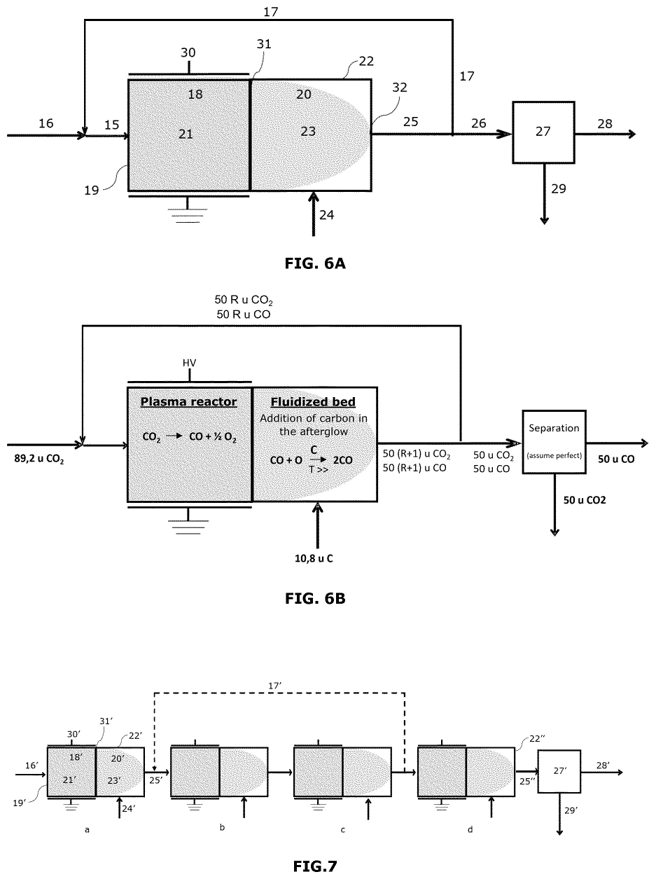

These embodiments may also be combined, wherein part of the product gas is recycled to the same plasma jet reactor, and a part is directed to a second plasma jet reactor. Examples of these embodiments are given by FIGS. 6A, 6B and 7 described below.

In an embodiment of the present invention, plasma jet technology, preferably atmospheric plasma jet technology, is combined with carbon-donor particles for the industrial conversion of CO2 to CO. Hereby, the plasma-splitting of the CO2 molecules is done in an environment where the CO radicals cannot immediately recombine with the oxygen radicals as these will be trapped even faster by the carbon-donor particles, in the plasma area and/or plasma afterglow area. The carbon-donor particles preferably comprise pure carbon. This is for instance achieved by activating the CO2 with the proper-energy plasma in a carbon bed of small particles of (pure) carbon, thus:

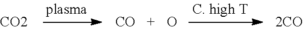

The concept is to add the carbon to the process through the use of particles of a carbon donor in a reaction chamber, preferably pure carbon. In this configuration, the activated O can be made to contact the added carbon and thus efficiently react with it to form CO. The carbon donor may preferably be natural coal, carbon black, activated coal, carbon fiber, cokes, etc. or any combination thereof. The gas streams can preferably be continuous. At least a part of the resulting product gas is recycled and fed into the same or another plasma reactor together with additional, fresh reactant gas comprising CO2.

The method comprises the step of converting the CO2 into CO using the reversible Boudouard reaction. The reversible Boudouard reaction is used to convert pure CO2 to pure CO based on the addition of carbon at high temperatures of at least 800° C.

Preferably, the plasma jet comprises an afterglow region. The afterglow region refers to a region downstream of the set of electrodes, wherein excited species of the process gas are present. In the present case, these excited species may be ionized species of O, CO, CO2, O, CO, CO2 radicals, excited neutral or charged O, CO, CO2 species, or any combination or mixture thereof. Preferably, the plasma jet afterglow comprises CO radicals and/or oxygen (O) radicals.

Preferably, the reaction chamber comprises the afterglow region of the plasma jet and/or preferably the carbon donor particles in the reaction chamber are subjected to the afterglow region of the plasma jet. Advantageously, the heat as well as presence of highly reactive species is utilized to improve the reaction equilibrium and reaction kinetics of the reverse Boudouard reaction. Advantageously, the heat drives the oxygen fixation in the carbon bed.

Preferably the afterglow region is optimized in length. This can preferably be achieved by using a volumetric flow of CO2 between 10 and 1000 standard liters per minute per individual plasma reactor. Furthermore, the afterglow region can be optimized by adjusting the plasma reactor power, in a range between 100 and 100,000 W per individual plasma reactor.

In a preferred embodiment, the plasma jet generator is chosen from the list of gliding arc (GA), glow discharge (GD), microwave discharge (MW), radiofrequency discharge (RF), capacitive coupled discharge (CCD) or dielectric barrier discharge, preferably gliding arc (GA) or glow discharge (GD), most preferably gliding arc.

In a further preferred embodiment, the plasma jet generator is chosen from
i. a Gliding Arc Plasmatron (GAP),
ii. a Dual-Vortex Plasmatron (DVP), or
iii. an Atmospheric Pressure Glow Discharge (APGD) plasma generator.

These plasma generators differ in their main performance characteristics, i.e. conversion and energy efficiency, as discussed below.

### the Reverse-Vortex Flow (RVF) Stabilized Gliding Arc Plasmatron (GAP)

The GAP falls in between, with conversion generally around 6-7% and energy efficiency of about 30%.

GAP is a medium to high-powered (500-800 W) atmospheric plasma source, with established conversion performance ˜6-7% (for pure CO2 splitting) and energy efficiency up to 32%, and 15% conversion with 65% energy efficiency for dry reforming of methane.

### the Atmospheric Pressure Glow Discharge (APGD)

The APGD on the other hand can deliver higher conversion (around 13%), but its energy efficiency is limited (25%). However, the lower energy efficiency is not a limiting factor in all cases. In a situation where heat recovery is desirable, the lower energy efficiency means that more heat will be available to be recovered from the gas and supplemented to the main process. Furthermore, if the electricity price is low at a given moment (peak trimming of renewable sources), the lower energy efficiency becomes less of a problem (see below), while the high conversion is beneficial.

APGD is a low to medium-powered (100-200 W) atmospheric plasma reactor. In its lab scale (shown below), the CO2 conversion reaches around 13% with energy efficiency of 25%.

### Dual-Vortex Plasmatron (DVP)

The DVP can deliver medium conversion (9-10%) at high energy efficiency. This means that it will utilize a larger part of the electrical energy towards CO2 splitting, potentially saving on electricity costs.

DVP atmospheric plasma reactor is a type of a GA discharge employing simultaneous vortex and reverse-vortex flow stabilization. It is a novel concept, configuring a dual-outlet, symmetric configuration. It is capable of CO2 conversion rate around 9.5% and efficiency up to 41% with 450 W of power.

Since the GAP, DVP and the APGD can run on the same type of power source, the system of the present invention may preferably comprise a combination of the three variations. Fundamentally, the three reactor technologies are very similar, so the end goal is a reactor that offers their best performance metrics.

Preferably, the plasma jet is obtained at about atmospheric pressure. Atmospheric pressure refers to a pressure close to 1 atm, preferably between 500 and 5000 hPa, more preferably at least 900 hPa, still more preferably at least 950 hPa, and/or more preferably at most 1100 hPa, still more preferably at most 1070 hPa, most preferably between 970 hPa and 1050 hPa, such as around 1013 hPa.

In a preferred embodiment of the invention, the process gas comprises CO2 and CO in a ratio by weight of at most 9/1, more preferably at most 8/2, more preferably at most 7/3, more preferably at most 6/4, more preferably at most 5/5. In another preferred embodiment of the invention, the process gas comprises CO2 and CO in a ratio by weight of at least 1/9, more preferably at least 2/8, more preferably at least 3/7, more preferably at least 4/6, more preferably at least 5/5. In another embodiment, the process gas comprises CO2 and CO in a ratio between 1/9 and 9/1, more preferably in a ratio between 2/8 and 8/2, more preferably in a ratio between 3/7 and 7/3, more preferably in a ratio between 4/6 and 6/4, most preferably in a ratio of about 5/5. Mixtures with lower and higher CO2 to CO ratios have low thermal efficiency of the full process; that is to say after separating each product stream.

The high CO concentration in the process gas is typically a direct result of the recycling or recirculation of the product gas without first separating the CO from said product gas in combination with the removal of oxygen by means of the carbon-donor particles, which inhibits the recombination of O2 and CO to CO2.

In a preferred embodiment, the product gas comprises O2 in an amount of at most 10 wt. %, more preferably at most 8 wt. % O2, more preferably at most 6 wt. % O2, more preferably at most 5 wt. % O2, more preferably at most 4 wt. % O2, more preferably at most 3 wt. % O2, more preferably at most 2 wt. % O2, more preferably at most 1 wt. % O2, more preferably at most 0.5 wt. % O2. The lack of oxygen is due to the fixation of O2 with carbon donor particles, thereby preferentially forming CO and optionally CO2. In another preferred embodiment, said process gas comprises O2 in an amount of at most 10 wt. %, more preferably at most 8 wt. % O2, more preferably at most 6 wt. % O2, more preferably at most 5 wt. % O2, more preferably at most 4 wt. % O2, more preferably at most 3 wt. % O2, more preferably at most 2 wt. % O2, more preferably at most 1 wt. % O2, more preferably at most 0.5 wt. % O2. Recycling with high oxygen content leads to recombination of O2 and CO to CO2. By fixating oxygen to CO through the carbon donor particles, oxygen in the process gas can be avoided without gas phase separation.

In a preferred embodiment of the invention, the process gas comprises product gas and reactant gas in a ratio by weight of at most 9/1, more preferably at most 8/2, more preferably at most 7/3, more preferably at most 6/4, more preferably at most 5/5. In another preferred embodiment of the invention, the process gas comprises product gas and reactant gas in a ratio by weight of at least 1/9, more preferably at least 2/8, more preferably at least 3/7, more preferably at least 4/6, more preferably at least 5/5. In another embodiment, the process gas comprises product gas and reactant gas in a ratio between 1/9 and 9/1, more preferably in a ratio between 2/8 and 8/2, more preferably in a ratio between 3/7 and 7/3, more preferably in a ratio between 4/6 and 6/4, most preferably in a ratio of about 5/5.

In a preferred embodiment of the invention, the reactant gas comprises CO2 at least 80% of CO2 by weight of the reactant gas. Preferably, said reactant gas comprises 90% of CO2 by weight, more preferably 95% of CO2 by weight. Reactant gas, as used herein, refers to fresh reactant which is added to the recycled part of the product gas. Preferably, the reactant gas is close to pure reactant in this case CO2. However, as purification of CO2 is a very energy and equipment intensive process, using exhaust streams comprising a high amount of CO2 with minimal purification can be preferred from an energetic point of view. Advantageously, present method handles impurities well, in particular oxygen, hydrogen, CO, hydrocarbons, nitrogen, nitrogen oxides, sulfur, sulfur oxides and hydrocarbons comprising sulfur may be included in the reactant gas. In comparison, impurities often need to be removed in catalytic processes.

In a preferred embodiment of the invention, the recycled part of the product gas comprising CO and CO2 is provided to the same plasma jet generator as in the first step (i.). In this way the recycling is carried out as a recirculation process within the same reactor. This set-up increases the residence time of the gasses in plasma het and the reaction chamber. Moreover, the use of one reactor reduces the heat and radiation losses.

In another preferred embodiment of the invention, the recycled part of the product gas comprising CO and CO2 is provided to a second plasma jet generator. In this way the recycling is carried out as a multistage recycling wherein the process comprises two or more reactors, wherein each reactor comprises a carbon reaction chamber and a plasma jet generator. This set-up makes for easier scale-up of the process.

In a preferred embodiment of the invention, a part of said product gas is extracted as extracted product gas, said extracted product gas comprising CO2 and CO in a ratio by weight of 9/1, 8/2, 7/3, 6/4, 5/5, 4/6, 3/7, 2/8, 1/9 or any ratio in between. Preferably, said extracted product gas comprises CO2 and CO in a ratio by weight of 6/4, 5/5, 4/6, 3/7, 2/8, 1/9 or any ratio in between. More preferably, said extracted product gas comprises CO2 and CO in a ratio by weight of 4/6, 3/7, 2/8, 1/9 or any ratio in between. The low CO2 to CO ratio makes separation in the separation easier. The high CO concentration in the extracted product gas is a direct result of the recycling or recirculation of the product gas without first separating the CO from said product gas.

In a preferred embodiment, the process gas may comprise additional gaseous species. In a preferred embodiment, the process gas may comprise inert or substantially inert gases such as N2 and argon. In another preferred embodiment, the inlet gas may comprise flu gasses, preferably flu gasses of combustion or metallurgic processes. Flu gasses generally contain nitrogen, argon, small amounts of oxygen and organic compounds. Oxygen and organic compounds are not desired but are generally broken down to CO2 and/or CO after a single pass through the plasma generator and carbon reaction chamber. The inventors have surprisingly found that nitrogen and argon have little impact on the conversion of CO2 to CO.

In a further embodiment, said extracted product gas comprising CO2 and CO is provided to a separation unit, wherein CO is purified from said extracted product gas. The separation unit separates CO at a higher concentration from a smaller gas stream, in comparison to conventional techniques where a separation unit is provided within the recycle loop.

In a preferred embodiment of the invention, at least 20% of the product gas is recycled, more preferably at least 25% of the product gas is recycled, more preferably at least 30% of the product gas is recycled, more preferably at least 35% of the product gas is recycled, more preferably at least 40% of the product gas is recycled, more preferably at least 45% of the product gas is recycled, more preferably at least 50% of the product gas is recycled, more preferably at least 55% of the product gas is recycled, more preferably at least 60% of the product gas is recycled, more preferably at least 65% of the product gas is recycled, more preferably at least 70% of the product gas is recycled, more preferably at least 75% of the product gas is recycled, more preferably at least 80% of the product gas is recycled, more preferably at least 85% of the product gas is recycled, more preferably at least 90% of the product gas is recycled.

In a preferred embodiment of the invention, the recycling step (v.) is repeated at least 2 times, preferably at least 4 times, more preferably at least 6 times and most preferably at least 8 times. The total CO2 conversion increases with increasing amount of recycling steps.

In a preferred embodiment of the invention, the carbon donor particles are carbon particles in the form of a fine powder. These can be preferably supplied through an additional inlet with a carrier gas, such as air, or together with the main process gas supply. The methods will most likely differ, as one will aid conversion in the post-plasma region (additional inlet), and the other will influence the plasma chemistry in the discharge Itself. For instance, carbon particles in the plasma may facilitate faster CO formation, but, on the other hand, consume molecular oxygen (O), which normally contributes to the CO2 splitting process (neutral impacts).

Preferably, said carbon-donor particles further comprise CO2-to-CO conversion catalysts.

In a particularly preferred embodiment of the invention, the carbon donor particles are in a fluidized state. In another embodiment, the carbon donor particles are positioned in a fixed bed. In still another embodiment, a down flow of carbon-donor particles is created, preferably under the influence of gravity, while the down flow of carbon-donor particles is exposed to O radicals, preferably in counter-flow to the down flow.

In fixed bed mode, the carbon particles preferably have sizes with an average radius between 0.1 and 50 mm. Most preferably, an average radius between 0.5 and 5 mm. In fluidized bed mode, the carbon particles preferably have sizes with an average radius between 5 and 5000 micron. Most preferably, an average radius between 5 and 500 micron.

In a further preferred embodiment, the porous carbon has a high specific surface area. The inventors found that solid carbon particles with a high specific surface area reduce the oxygen content after each pass, increase conversion and increase energy efficiency. In a preferred embodiment, the porous carbon has a surface area of at least 300 m²/g, more preferably at least 400 m²/g, more preferably at least 500 m²/g, more preferably at least 600 m²/g, more preferably at least 700 m²/g, more preferably at least 800 m²/g, more preferably at least 900 m²/g, more preferably at least 1000 m²/g, more preferably at least 1100 m²/g, more preferably at least 1200 m²/g. The surface area is measured according ISO 9277.

In a preferred embodiment of the invention, the carbon-donor particles are carbon-donor particles in the form of a fine powder. The powder is preferably supplied through an additional inlet for carbon-donor particles to aid conversion in the plasma afterglow region, and the supply can hereby preferably be achieved using a carrier gas (such as air or CO2), or the powder may be supplied together with the main CO2 supply to influence the plasma chemistry in the discharge. For instance, carbon-donor particles in the plasma may facilitate faster CO formation, while carbon-donor particles provided in a separate inlet may allow more efficient splitting of CO2 into CO and O.

In a second aspect, the invention relates to a system for converting CO2 to CO.

In a preferred embodiment of the invention, the system comprises:
a carbon reaction chamber comprising a gas inlet and a gas outlet,
a plasma jet generator comprising:
   a process gas inlet suitable for supplying the plasma jet generator with process gas comprising CO₂,
   a plasma jet outlet in fluid communication with the gas inlet of the carbon reaction chamber, and
   a set of electrodes suitable for igniting a plasma in the process gas,
wherein said gas outlet of the carbon reaction chamber is in fluid communication with the process gas inlet of a plasma jet generator.

In a particularly preferred embodiment of the invention, said gas outlet of the reaction chamber is in fluid communication with the process gas inlet of a plasma jet generator.

The fluid communication between said gas outlet and said process gas inlet is allows recycling of a product gas. It has been shown that recycling at least part of the product gas and providing said product gas comprising CO and CO2 to a plasma jet generator has a beneficial influence on the CO2 conversion. Recirculation of the product gas for two or more times through a plasma jet generator and carbon reaction chamber for O2 removal increases the total CO2 conversion significantly.

The recycling referred to in this disclosure can refer to the recycling of at least part of the product gas and providing said product gas comprising CO and CO2 to the same plasma jet generator (as a recirculation) or providing said product gas comprising CO and CO2 to a second plasma jet generator (as a multistage recycling).

In some embodiments, the system comprises:
a carbon reaction chamber comprising a gas inlet and a gas outlet,
a plasma jet generator comprising:
   a process gas inlet suitable for supplying the plasma jet generator with process gas comprising CO₂,
   a plasma jet outlet in fluid communication with the gas inlet of the carbon reaction chamber, and
   a set of electrodes suitable for igniting a plasma in the process gas,
wherein said gas outlet of the carbon reaction chamber is in fluid communication with the process gas inlet of said plasma jet generator.

In other embodiments, the system comprises:
a first carbon reaction chamber comprising a gas inlet and a gas outlet,
a first plasma jet generator comprising:
   a process gas inlet suitable for supplying the plasma jet generator with process gas comprising CO₂,
   a plasma jet outlet in fluid communication with the gas inlet of the first carbon reaction chamber, and
   a set of electrodes suitable for igniting a plasma in the process gas,
wherein said gas outlet of the first carbon reaction chamber is in fluid communication with a process gas inlet of a second plasma jet generator.

The second plasma jet generator comprises thus a process gas inlet, a plasma jet outlet in fluid communication with the gas inlet of a second carbon reaction chamber, and a set of electrodes suitable for igniting a plasma in the process or product gas, wherein the second carbon reaction chamber comprises also a gas inlet and a gas outlet.

These embodiments may also be combined so that said gas outlet of the first carbon reaction chamber is in fluid communication with the process gas inlet of said first plasma jet generator and in fluid communication with the process gas inlet of a second plasma jet generator.

The reverse Boudouard reaction is used to convert pure CO2 to pure CO based on the addition of carbon at high temperatures of at least 800° C. Hence, preferably the reaction chamber comprises a temperature controlling system, which preferably is configured to keep the temperature in the reaction chamber at least at 800° C.

Oxygen (O and O2) is fixated in the carbon to form CO at a temperature of 700° C. or higher. Hence, preferably the reaction chamber comprises a temperature controlling system, which preferably is configured to keep the temperature in the reaction chamber at least at 700° C., more preferably the temperature in the reaction chamber is at least 750° C., more preferably the temperature in the reaction chamber is at least 800° C., more preferably the temperature in the reaction chamber is at least 850° C., more preferably the temperature in the reaction chamber is at least 900° C., more preferably the temperature in the reaction chamber is at least 950° C., more preferably the temperature in the reaction chamber is at least 1000° C.

In a preferred embodiment of the system, the plasma jet outlet is positioned in the reaction chamber, ensuring that the plasma jet afterglow is within the reaction chamber and the carbon-donor, preferably carbon-donor particles, more preferably the pure carbon particles, are subjected to the plasma jet afterglow containing excited CO2 species.

In a preferred embodiment, the plasma jet generator is chosen from the list of gliding arc (GA), glow discharge (GD), microwave discharge (MW), radiofrequency discharge (RF), capacitive coupled discharge (CCD) or dielectric barrier discharge, preferably gliding arc (GA) or glow discharge (GD), most preferably gliding arc.

In a further preferred embodiment, the plasma jet generator comprises
i. a Gliding Arc Plasmatron (GAP), or
ii. a Dual-Vortex Plasmatron (DVP), or
iii. an Atmospheric Pressure Glow Discharge (APGD) plasma generator.

In a preferred embodiment, the plasma said plasma jet generator comprises a multitude of similarly, preferably equally, sized plasma reactors suitable for parallel operation. Upscaling plasma reactors is often difficult and problematic due to the non-linear nature of atmospheric plasmas. Advantageously, the plasma generating means may comprise a stack of similarly sized plasma reactors operating in parallel. The plasma reactor stack may advantageously be connected to a single carbon reaction chamber. In a preferred embodiment, the plasma generating means comprises, preferably consists of, a stack of at least 2, more preferably at least 3, more preferably at least 4, more preferably at least 5, more preferably at least 6, more preferably at least 8, more preferably at least 10, more preferably at least 12, more preferably at least 14, most preferably at least 16 similarly sized, preferably equally sized, plasma reactor modules connected to operate in series. In a preferred embodiment, the plasma generating means comprises, preferably consists of, a stack of at most 50, more preferably at most 40, more preferably at most 30, more preferably at most 25, most preferably at most 20 similarly sized, preferably equally sized, plasma reactor modules connected to operate in series. In a preferred embodiment multiple plasma reactor modules are connected to a single carbon reaction chamber, the stack of plasma reactor modules, that is to say all plasma reactor modules, are connected to a single carbon reaction chamber.

The carbon reaction chamber comprises means suitable for holding or providing a carbon donor. Preferably the carbon donor is a solid particle comprising carbon. More preferably, the carbon reaction chamber comprises (a) means to hold a fixed, preferably porous carbon bed and/or (b) means to fluidize carbon particles, preferably porous carbon particles. Solid carbon is preferred because it makes process control easier than addition of gaseous species and because it allows using carbon donors with fewer non-carbon elements. For example, gaseous hydrocarbons can be used as carbon donor but introduce hydrogen into the recycle system. This has several undesired effects, such as the formation of water, reduction of conversion and energy efficiency and an increase in fouling. Porous carbon is preferred as it drastically increases the gas-solid interface at which reaction takes place.

In a particular, preferred embodiment of the invention, the carbon reaction chamber is a fluidized bed reactor configured to fluidize the carbon donor particles. In a further preferred embodiment, the system comprises a continuous carbon feed, preferably said continuous carbon feed is a gravity-driven silo, rotating screw, conveyer belt or a combination thereof; suitable to provide the fluidized bed with carbon donor particles. This advantageously allows fully continuous operation.

In another particular, preferred embodiment, the carbon reaction chamber is a fixed carbon bed. Preferably, the position of said fixed carbon bed can be adjusted.

In still another embodiment, the carbon reaction chamber is a powder down flow reaction chamber configured to create a down flow of carbon-donor particles, preferably under the influence of gravity, while exposing the down flow of carbon-donor particles to O radicals.

In an embodiment of the invention, the system comprises catalysts. Particular catalysts of interest are CO2-to-CO conversion catalysts as well as catalysts for the reverse Boudouard reaction.

In a preferred embodiment of the invention, the reaction chamber comprises a particle inlet for introducing carbon-donor particles in the reaction chamber, preferably for continuously introducing carbon-donor particles in the reaction chamber.

In a preferred embodiment of the invention, said fluid communication between the gas outlet of the reaction chamber and the process gas inlet of a plasma jet generator does not comprise a gas separation unit. This allows for recycling of a product gas, without purification or separation in between recycling passes.

In a preferred embodiment of the invention, said gas outlet of the reaction chamber is in fluid communication with the process gas inlet of said plasma jet generator. This allows for recirculation of the product gas in one system, wherein the product gas can be redirected to the process gas inlet of the plasma generator. This set-up increases the residence time of the gasses in plasma het and the reaction chamber. Moreover, the use of one reactor reduces the heat and radiation losses.

In another preferred embodiment of the invention, said gas outlet of the reaction chamber is in fluid communication with the process gas inlet of second plasma jet generator, preferably in a second reactor comprising a carbon reaction chamber. In this way the recycling can be carried out as a multistage recycling wherein the system comprises two or more reactors, wherein each reactor comprises a carbon reaction chamber and a plasma jet generator. This set-up makes for easier scale-up of the process.

In still another preferred embodiment of the invention, said gas outlet of the reaction chamber is in fluid communication with the process gas inlet of a first plasma jet generator and with the process gas inlet of a second plasma jet generator, preferably in a second reactor comprising a carbon reaction chamber. In this way the recycling can be carried out as a multistage recycling with recirculation wherein the system comprises two or more reactors and a recirculation cycle, wherein each reactor comprises a carbon reaction chamber and a plasma jet generator. This set-up makes for easier scale-up of the process. The recirculation cycle can be positioned in between any of the reactors, for example, the gas outlet of the reaction chamber of the second reactor can be in fluid communication with the process gas inlet of the plasma jet generator of a third reactor and with the process gas inlet of its own plasma jet generator.

The invention is further described by the following non-limiting examples which further illustrate the invention, and are not intended to, nor should they be interpreted to, limit the scope of the invention.

### EXAMPLES AND DESCRIPTION OF FIGURES

### The Reverse Boudouard Reaction

The Boudouard reaction, named after Octave Leopold Boudouard, is the redox reaction of a chemical equilibrium mixture of carbon monoxide and carbon dioxide at a given temperature. Of particular interest in this application is its reverse, the disproportionation of carbon monoxide into carbon dioxide and graphite or its reverse:

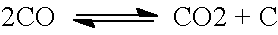

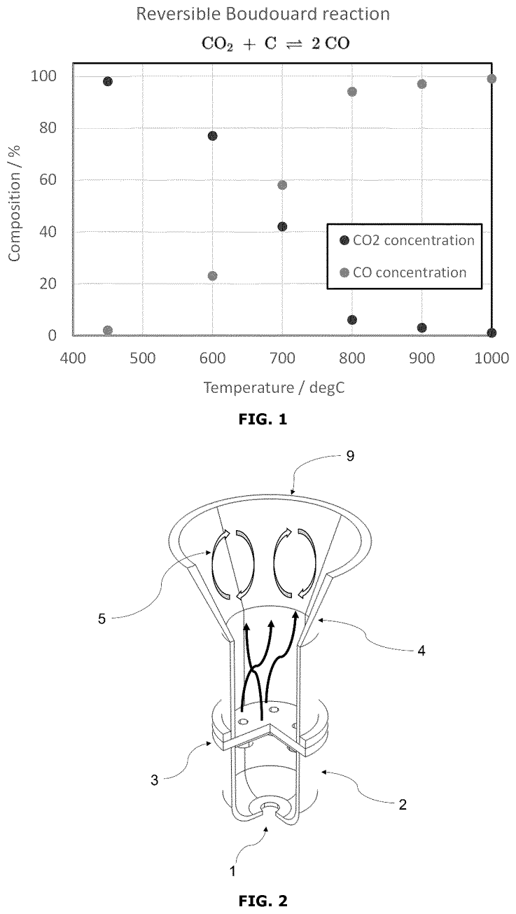

The reverse Boudouard reaction is endothermic, with a ΔH of 172 kJ/mol. A higher temperature shifts the equilibrium—entirely in accordance with Le Chatelier's principle—to the product side (carbon monoxide). With a pressure increase, the balance shifts to the other side, because the number of gas molecules then decreases. FIG. 1 and Table 1 below shows the percentage composition of the equilibrium mixture at various temperatures (each time under standard pressure of 100,000 Pa).

TABLE 1

| Temperature (° C.) | % CO2 | % CO |
|---|---|---|
| 450 | 98 | 2 |
| 600 | 77 | 23 |
| 700 | 42 | 58 |
| 800 | 6 | 94 |
| 900 | 3 | 97 |
| 1000 | 1 | 99 |

### Example 1: Composition of the Process Gas

Preferably, the process gas comprises CO2 and CO and optionally traces of O2, more preferably the process gas consists of CO2 and CO and optionally traces of O2. However, most point CO2 sources available in industry do not provide clean CO2. Hence, in another preferred embodiment, the process gas may comprises other gasses in addition to CO2 and CO gas. In a particularly preferred embodiment, the process gas is a mixed gas stream comprising CO2 and any or any combination of the following gasses: nitrogen (N2), hydrogen (H2), water (H2O), and methane (CH4). In table 2, an exemplary mixture of preferred process gas, preferably coming from a blast furnace, is disclosed:

TABLE 2

| Type | vol % |
|---|---|
| Nitrogen | 46.59 |
| Carbon dioxide (CO2) | 24.50 |
| Carbon monoxide (CO) | 23.85 |
| Hydrogen (H2) | 3.84 |
| Oxygen (O2) | 1.20 |
| Methane (CH4) | 0.016 |

Other gasses in the process gas may include benzene, toluene, ethylene and/or acetylene, preferably in very small concentrations (of 10 vol. ppm or less). Note that the main non-CO2 gas is preferably N2, e.g. at 46.59 vol %. However, N2 in concentrations up to 50% does not negatively seem to impact the effective conversion or energy efficiency. The oxygen content is preferably rather small (less than 5 vol %, such as about 1.2%). We note that the process and system of present invention minimizes the oxygen content after the carbon bed, thus reducing the oxygen content in the recycled process gas.

### Example 2: Plasma Jet Outlet

A preferred embodiment of the system is illustrated in FIG. 2. Process gas 1, comprising CO2, is provided to pressure chamber 2, which is fluidly connected to four (three shown) gliding arc plasma generators 3. The plasma jet is directed into fluidized bed 4, which acts as carbon reaction chamber, in which carbon particles are recirculated 5. At the top of the fluidized bed, product gas 9 comprising CO is extracted. A part of the extracted product gas 9 is recycled and included in process gas 1.

### Example 3: Carbon Reaction Chamber

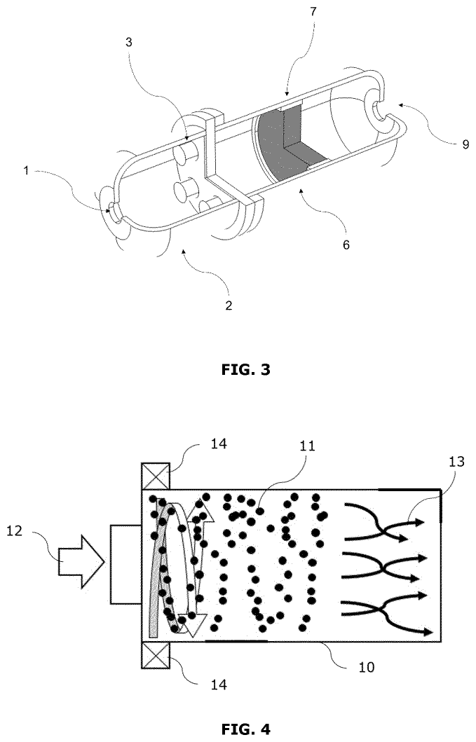

Example 3 is a preferred embodiment of a system according to the present invention utilizing a fixed carbon bed. In FIG. 3, a carbon reaction chamber 6 with a fixed carbon particle bed 7 is shown. Process gas 1 comprising CO2 is provided to pressure chamber 2, which is fluidly connected to four (three shown) gliding arc plasma generators 3. The plasma jet is directed into the carbon reaction chamber 6, in which a fixed, porous carbon bed 7 is located. The longitudinal position of the fixed, porous carbon bed 7 can be adjusted to optimize the fixation of oxygen and the production of CO. Product gas 9 is extracted from the carbon reaction chamber 6. A part of the extracted product gas 9 is recycled and included in process gas 1.

The purpose is to facilitate the reverse Boudouard reaction internally. The fixed carbon bed can preferably be optimized using fluid dynamics and plasma model simulations or lab testing, and the focus can be at increasing the residence time inside the carbon bed and achieving optimum reaction temperature (preferably at least 1200K). Furthermore, the carbon particles size, shape, porosity, surface area as well as carbon bed length and residence time can be optimized.

### Example 4

In FIG. 4, a carbon reaction chamber 10 with pulverized carbon particles 11 is shown. A mixture of CO2, CO and O2 enters 12 the carbon reaction chamber 10. In the carbon reaction chamber 10, the carbon (C) in the pulverized carbon particles 11 reacts with O to form CO. Hence, a CO-enriched gas stream 13 leaves the carbon reaction chamber 10. Advantageously, the pulverized carbon particles 11 are supplied to the carbon reaction chamber by two inlets 14 in such a way that a vortex flow is formed. This improves mixing and increases the contact time between reactive species, particularly in the afterglow of a plasma generator, and the carbon particles.

### Comparative Example 5 and Example 6

An experiment was performed to test the influence of the carbon bed on multiple passes through a plasma generator without separation between each pass. The output of the system was recycled in its entirety and used as process gas. The CO2 conversion per pass as well as the energy efficiency per pass were determined. The experiment was carried out with three repetitions for four passes per repetition.

In comparative example 5, CO2 was sent through a system according to example 3 in which the fixed carbon bed was removed. There was no carbon donor present.

In example 6, CO2 was sent through the same system as shown in example 3, but with the fixed carbon bed in place.

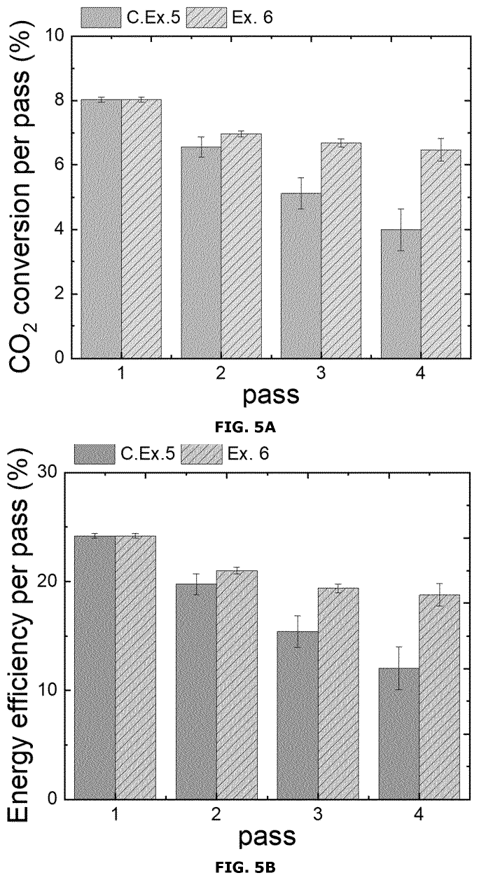

FIG. 5A shows the conversion per pass for c.ex. 5 and example 6. FIG. 5A shows that the CO2 conversion per pass drops from 8.09 to 6.46% from first to fourth pass in example 6. Without a carbon donor, the conversion per pass drops to 4.04% by the fourth pass.

FIG. 5B shows the energy efficiency (represented by specific energy input (SEI)) per pass for comparative example 5 and example 6. The energy efficiency shows the same trend as the conversion. Example 6 shows the energy efficiency per pass dropping from 24% to 19% from the first to fourth pass. Comparative example 5 shows a much greater decline in energy efficiency, dropping from 24 to 12% respectively.

We note that the effect of the carbon bed on a single pass is quite small. However, for each additional pass without separation of the products, the conversion and energy efficiency are improved when the carbon bed is present. The difference in cumulative conversion as well as energy efficiency is substantial and increases with each additional pass.

### Example 7: Process Design and Mass Balances

Example 6 refers to an embodiment of the present invention, wherein a part of the plasma reactor output is recycled without separation. The extracted product is sent to a separation unit. This allows a separation unit operating at a higher CO to CO₂ concentration and a smaller mass flow rate compared to a similar setup without a carbon reaction chamber.

To better exemplify reference is made to FIGS. 6A and 6B. Process gas comprising CO2 and CO 15 enters a plasma jet generator 19, wherein a plasma 18 is generated by plasma generating means 30, preferably electrodes with a high potential difference. The CO2 in the process gas 15 is converted to CO and ½ O2 according to the chemical reaction:

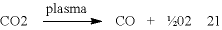

The plasma jet generator 19 and the carbon reaction chamber comprising carbon donor particles 22 are in fluid connection 31. The plasma jet afterglow 20 reaches in the carbon reaction chamber 22. In the carbon reaction chamber 22 oxygen is captured by the carbon donor particles and converted to CO according to the chemical reaction:

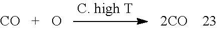

The carbon donor particles are supplied to the reaction carbon chamber 22 by a carbon particle inlet 24. A product gas comprising CO2 and CO 25 leaves the carbon reaction chamber 22 through a gas outlet 32. A part of the product gas 25 is recycled as recycled product gas 17. The recycled product gas 17 is enriched with reactant gas comprising CO2 16 to enter the plasma jet generator 19 as process gas 15. A second part of the product gas 25 is extracted as extracted product gas comprising CO2 and CO 26 and provided to a separation unit 27. In the separation unit 27, the extracted product gas 26 is separated into a CO gas stream 28 and a CO2 gas stream 29.

FIG. 6B shows a steady-state mass balance for the reactor unit of FIG. 6A. The steady state mass balance was determined by estimating a 50/50 mixture of CO2 and CO by weight can be obtained. The denotation “u” was used as an arbitrary unit for mass flow rate. Fixation of oxygen in the carbon reaction chamber 22 was assumed to be perfect, that is to say no oxygen was present in the product. Separation 27 was also assumed to be perfect. In this example, 10% of the product gas 25 is extracted product gas 26 to be separated. The recycle ratio R is the ratio of the mass flow of the recycle to the mass flow of the combined inputs (both carbon and CO2).

### Example 8: Reaction Scheme

Example 8 refers to a preferred embodiment of the present invention, wherein the plasma reactor output is recycled without separation to a second plasma reactor. To better exemplify reference is made to FIG. 7. Reactant gas comprising CO2 and optionally CO 16′ enters a plasma jet generator 19′, wherein a plasma 18′ is generated by plasma generating means 30′, preferably electrodes with a high potential difference. The CO2 in the reactant gas 16′ is converted to CO and ½ O2 according to the chemical reaction:

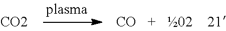

The plasma jet generator 19′ and the carbon reaction chamber comprising carbon donor particles 22′ are in fluid connection 31′. The plasma jet afterglow 20′ reaches in the carbon reaction chamber 22′. In the carbon reaction chamber 22′ oxygen is captured by the carbon donor particles and converted to CO according to the chemical reaction:

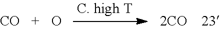

The carbon donor particles are supplied to the reaction carbon chamber 22′ by a carbon particle inlet 24′. A product gas comprising CO2 and CO 25′ leaves the carbon reaction chamber 22′ and enters a second plasma reactor b as described above. In this embodiment of the invention the gas stream is sent through four plasma reactors (a, b, c, d). When the product gas comprising CO2 and CO 25″ leaves the carbon reaction chamber 22″ of the last serial plasma reactor, in this embodiment plasma reactor d, the product gas comprising CO2 and CO 25″ is extracted and provided to a separation unit 27′. In the separation unit 27′, the extracted product gas 25″ is separated into a CO gas stream 28′ and a CO2 gas stream 29′. It is an option to provide a recirculation into the system or the process, wherein a part of the product gas leaving a plasma reactor can be recycled as recycled product gas 17′ to the inlet of a previous plasma reactor.

### Example 9: Carbon Feeding System

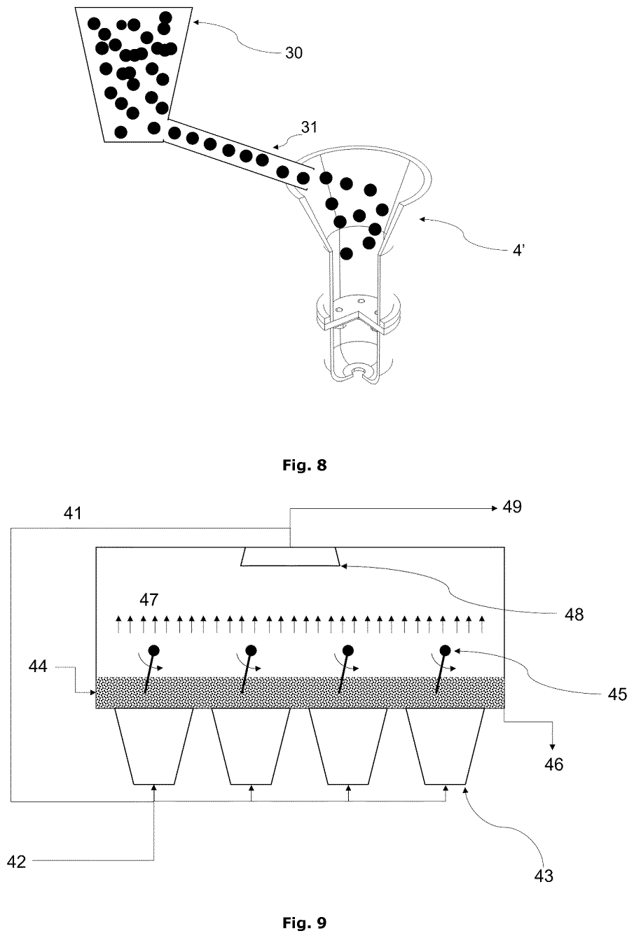

FIG. 8 shows a schematic of a fluidized carbon bed 4′ which is continuously fed carbon particles through a gravity-based transport system 31 connected to a carbon silo 30.

### Example 10: Parallel Plasma Reactors Sharing Common Fluidized Carbon Bed

FIG. 9 shows a schematic of a system according to a preferred embodiment of the present invention. FIG. 9 shows a system featuring multiple (four shown) plasma reactor nodes 43 which share a common fluidized carbon bed. A continuous carbon feed 44 supplies carbon particles to the fluidized carbon bed, which is transported by a continuous transport system with rotating flaps 45 to the ash disposal system 46. Product gas 47 flows upwards towards a gas collection system 48, preferably provided with a filter to prevent passage of solids. Part of the collected product gas is extracted 49. The remainder of the collected product gas is recycled to the plasma reactor nodes 43, through recirculation channel 41, in addition to fresh reactant 42, i.e. a stream of gas comprising CO₂.

1. A method for converting CO₂ to CO, comprising the steps of:
providing process gas comprising CO₂ and optionally CO, to a plasma jet generator;
igniting a plasma in the process gas by the plasma jet generator, thereby obtaining a plasma jet comprising CO and O species;
introducing the plasma jet into a carbon reaction chamber comprising carbon donor particles, thereby allowing O species in the plasma jet to preferentially bind with carbon to form CO;
extracting product gas from the carbon reaction chamber, said product gas comprising said CO and CO₂; and
recycling at least part of the product gas and providing said product gas comprising CO and CO₂ to said plasma jet generator or to a second plasma jet generator.

2. The method according to claim 1, wherein said process gas comprises product gas and a reactant gas in a ratio by weight of at most 8/2, optionally said reactant gas comprising at least 80 wt. % of CO₂, relative to the total weight of the reactant gas.

3. The method according to claim 1, wherein the recycled part of the product gas comprising CO and CO₂ is provided to the same plasma jet generator as in the providing step.

4. The method according to claim 1, wherein the recycled part of the product gas comprising CO and CO₂ is provided to a second plasma jet generator.

5. The method according to claim 1, wherein a part of said product gas is extracted as extracted product gas, said extracted product gas comprising at most 50% CO₂.

6. The method according to claim 5, wherein said extracted product gas comprising 40% CO₂ and CO is provided to a separation unit, wherein CO is purified from said extracted product gas.

7. The method according to claim 1, wherein at least 50% of the product gas is recycled.

8. The method according to claim 1, wherein the carbon donor particles are in a fluidized state.

9. The method according to claim 1, wherein the recycling step is repeated at least 2 times.

10. A system for converting CO₂ to CO, comprising:
a carbon reaction chamber comprising a gas inlet and a gas outlet,
a plasma jet generator comprising:
a process gas inlet suitable for supplying the plasma jet generator with process gas comprising CO₂,
a plasma jet outlet in fluid communication with the gas inlet of the carbon reaction chamber, and
a set of electrodes suitable for igniting a plasma in the process gas,
wherein said gas outlet of the carbon reaction chamber is in fluid communication with the process gas inlet of said plasma jet generator or wherein said gas outlet of the carbon reaction chamber is in fluid communication with the process gas inlet of a second plasma jet generator.

11. The system according to claim 10, wherein said fluid communication between the gas outlet of the carbon reaction chamber and the process gas inlet of a plasma jet generator does not comprise a gas separation unit.

12. The system according to claim 10, wherein said gas outlet of the carbon reaction chamber is in fluid communication with the process gas inlet of the plasma jet generator.

13. The system according to claim 10, wherein said gas outlet of the carbon reaction chamber is in fluid communication with the process gas inlet of a second plasma jet generator.

14. The system according to claim 10, said system comprising a continuous carbon feed.

15. The system according to claim 10, wherein said plasma jet generator comprises a multitude of similarly sized plasma reactors suitable for parallel operation.
